(19) United States
(12) Patent Application Publication
(10) Pub. No.: US 2010/0237550 A1
(43) Pub. Date: Sep. 23, 2010

(54) Elastic member, slide device using the elastic member, and electric device using the slide device

(76) Inventor: Noriaki Kubota, Tokyo (JP)

Correspondence Address: Kubotera & Associates, LLC, 200 Daingerfield Rd, Suite 202, Alexandria, VA, 22314, US

(21) Appl. No.: 12/385,673

(22) Filed: Apr. 15, 2009

(30) Foreign Application Priority Data
Mar. 17, 2009 (JP) 2009-64103

(51) Int. Cl. F16F 1/18

(52) U.S. Cl. 267/159

(57) ABSTRACT

An elastic member used for a slide device includes a plurality of spring wires and first and second connecting sections that are locked to one ends and the other ends of the spring wires, respectively. Locking ends are formed at one ends and the other ends of the spring wires, both ends of the spring wires including the locking ends are formed in a symmetrical shape, the connecting sections include retaining engagement portions that make the plurality of spring wires be engaged with the connecting sections, and the first and second connecting sections are separately formed by forming the same assembling members and the same superposed members. If the assembling members are fixed to the superposed members while the ends of the spring wires are fitted to the grooves of the retaining engagement portions and the superposed members are assembled to be superposed on the assembling members, the ends of the plurality of spring wires are disposed at predetermined intervals and retained by the connecting sections.

### BACKGROUND

1. Technical Field

The present invention relates to an elastic member, a slide device using the elastic member, and an electric device such as a mobile phone or a mobile device using the slide device.

2. Related Art

In the past, for example, there has been a slide mobile phone where an operating section including numerical keys and function keys are provided on an upper surface of the main body unit, a display section such as a liquid crystal panel for performing predetermined display is provided on an upper surface of a superposed unit superposed on the main body unit, and the main body unit and the superposed unit are moved relative to each other in a longitudinal direction.

The slide mobile phone has a structure where guide rails serving as slide guides are provided at the left and right portions on the superposed unit with a gap therebetween, the main body unit is provided with a slide portion that is slidably engaged with the left and right guide rails, and the slide portion slides relative to the guide rails, so that the superposed unit and the main body unit slide relative to each other.

A slide device, which achieves the slide structure of the above-mentioned slide mobile phone, has a structure where both ends of the slide portion are slidably engaged between the slide guides that are provided at the left and right portions as described above so that the slide portion is slidably engaged with the slide guides.

That is, for example, a first member of first and second members, which are to be slidably engaged with each other, is provided with two guide rails facing each other. The second member is provided with a slide portion that includes slide engagement portions at both ends thereof, or the second member, which is provided with slide engagement portions slidably engaged with the guide rail at both ends thereof, is formed as a slide portion. The slide engagement portions formed at the both ends of the second member is slidably engaged with the slide guides of the first member, the slide portion is slidably engaged between the slide guides, so that the second member is slidably engaged with the first member.

Meanwhile, the slide mobile phone, which uses the slide device connecting the main body unit with the superposed unit to allow the superposed unit to slide on the main body unit as described above, is preferably formed to be positioned (to be pushed for closing or opening, or click engaged) at a superposed closed position where an operating section of the main body unit is hidden by the superposed unit, and a slide open position where the superposed unit slides in a longitudinal direction and is displaced to make the operating section be exposed to the outside.

Accordingly, in order to meet these demands, there has been known a slide device where one end of the elastic member is connected to the first member and the other end thereof is connected to the second member so that a force in a slide direction is generated between the first and second members by the elasticity of the elastic member.

That is, for example, there has been the following slide device (hereinafter, referred to as a “torsion spring type” slide device). In this slide device, a torsion spring, where a portion of a wire between both ends thereof is wound several times in the shape of a coil and the wire is formed as a whole in a V shape using the coil-shaped portion as an apex, is formed as an elastic member, and one end of the torsion spring is connected to the first member and the other end thereof is connected to the second member so that a force in a slide direction is generated between the first and second members by an elastic force (angle increasing force) that separates connecting sections of both ends of the torsion spring from each other.

Further, for example, there has been the following slide device (hereinafter, referred to as a “spring unit type” slide device). In this slide device, as shown in FIG. 10, a spring unit, consisting of a plurality of coil-shaped compression-resistant springs 14 arranged parallel with one another in a frame-shaped unit base 15, is formed as an elastic member 4, and one end of the spring unit is connected to the first member and the other end thereof is connected to the second member so that a biasing force in a slide direction is generated between the first and second members by an elastic force that separates connecting sections of both ends of the spring unit from each other.

When a biasing force, which is generated in the slide direction from an elastic force of the elastic member as described above, is used, it may be possible to achieve, for example, a positioning function that closes the superposed unit with respect to the main body unit of the slide mobile phone so that the superposed unit is positioned at the superposed closed position, or to open the superposed unit with respect to the main body unit so that the superposed unit is positioned at the slide open position.

Examples of the related art:

Patent Document: Japanese Patent Laid-Open Publication No. 2005-291315A

Patent Document: Japanese Patent Laid-Open Publication No. 2006-217594A

Patent Document: Japanese Patent Laid-Open Publication No. 2007-028417A

However, the above-mentioned conventional devices have various problems, respectively. That is, for example, since the sliding distances of the first and second members are limited according to free length and contact length of each of the compression-resistant springs 14 of the spring unit due to the structure thereof, the spring unit type slide device shown in FIG. 10 may be applied to only a device having a slide structure of which the sliding distance is small.

Further, in order to manufacture the elastic member, that is, the spring unit, a plurality of shafts (not shown) and compression-resistant springs 14 are used, and there is required a very troublesome work for assembling the plurality of compression-resistant springs 14 and shafts with the frame-shaped unit base 15 while bending the compression-resistant springs 14. This causes high cost and difficulty in manufacture.

On the other hand, the torsion spring type slide device has a structure that significantly increases or widening a distance between the connecting sections of both ends of the torsion spring by bending the wire. Accordingly, the torsion spring type slide device may have a structure that is suitable for setting a long sliding distance as compared to the above-mentioned spring unit type slide device. However, considering the stress and load of the torsion spring, there is also a limit on the sliding distance. That is, when a strong torsion spring is employed so that a sufficiently large biasing force in the slide direction is generated in a large sliding range, stress is increased correspondingly. For this reason, a sliding operation against the elastic force of the torsion spring becomes heavy, that is, operability is sacrificed.

Further, since a wire is wound several (three to four) times at a coil-shaped portion that is formed between the both ends of the torsion spring of the torsion spring type slide device, inevitably a space becomes bulky due to the corresponding increase of thickness. In addition, when the above-mentioned slide device is applied to an electric device such as a mobile phone, a FPC (flexible printed circuit board) is often disposed in the vicinity of the coil-shaped portion of the torsion spring. Accordingly, the thickness of the coil-shaped portion of the torsion spring obstructs the disposition of an electronic component such as a FPC, and eventually obstructs the reduction and compactness by the thickness of this kind of electric device.

### SUMMARY

The present invention addresses the above-identified, and other problems associated with conventional methods and apparatuses. The present invention provides an elastic member of a slide device that may be set to a long sliding distance, avoid a problem of the increase of a space caused by a thickness, easily set the strength of an elastic force of an elastic member, and be excellent in mass productivity and cost by further progressing research and development about this kind of slide device that generates a force in a slide direction by an elastic force of an elastic member; the slide device; and an electric device using the slide device.

According to a first embodiment of the invention, there is provided an elastic member used between first and second members of a slide device where the first and second members are superposed and connected to each other so as to slide in a direction of a superposition surface, the elastic member includes a plurality of elastically bending spring wires, and first and second connecting sections that are locked to one ends and the other ends of the spring wires, respectively, wherein each of the spring wires has the shape of a predetermined bent wire including an arcuately bent portion, bent or curved locking ends are formed at one ends and the other ends of the spring wires, and both ends of the spring wire including the locking ends are formed in a symmetrical shape; the connecting sections include retaining engagement portions that make the ends of the plurality of spring wires be engaged with the connecting sections in a retaining state at predetermined parallel intervals; the first and second connecting sections are obtained by separately forming the same assembling members and the same superposed members, and fixing the assembling members to the superposed members while the superposed members are assembled to be superposed on the assembling members; the superposition surfaces of one of the assembling members and the superposed members have a groove shape that substantially matches with the locking ends 8 of the spring wire, and plurality of grooves to which the locking ends are fitted are formed on the superposition surfaces so that the plurality of grooves are formed as the retaining engagement portions; and wherein the assembling members are fixed to the superposed members while the ends of the spring wires are fitted to the grooves of the retaining engagement portions thereby the superposed members are assembled to be superposed on the assembling members, the ends of the plurality of spring wires are disposed at predetermined parallel intervals and held by the connecting sections.

According to a second embodiment of the invention, in the elastic member 4 described in the first embodiment, there is provided a slide device where pivot holes 12, which are used to connect the first and second connecting sections to the first and second members 1 and 2 of the slide device, respectively, are formed at portion of the first and second connecting sections 5 and 6, which are fixed and assembled in the superposed state, opposite to the spring wires 4A, wherein the pivot hole 12 of the first connecting section 5 is connected to the first member 1 of the slide device and the pivot hole 12 of the second connecting section 6 is connected to the second member 2 so that an elastic force is generated in a slide direction between the first and second members 1 and 2.

According to a third embodiment of the invention, there is provided an electric device in which a main body unit and a superposed unit of an electric device are superposed; and the main body unit and the superposed unit are connected to each other by the slide device according to the second embodiment so that the superposed unit slides to relatively cross from the superposed state in a direction of a superposition surface and exposes a part of the superposition surface to the outside.

Since the invention has the above-mentioned structure, the elastic member is not formed of the spring unit or the torsion spring in the related art and is formed of a plurality of flat and bent spring wires that are arranged parallel with one another. Accordingly, it may be possible to set the elastic member to a long sliding distance. Further, it may be possible to simply and variously adjust the strength of an elastic force of the elastic member and to achieve a biasing force in a desired slide direction by appropriately setting the length, shape, or the number of spring wires in consideration of required operability or a sliding distance.

In addition, it may be possible to obtain a very practical slide device that may overcome problems of this kind of slide device in the related art, that is, may avoid a problem of having, a bulky space caused by a thickness and easily make the slide device thin and compact, and may be easily manufactured and be excellent in mass productivity and cost.

Further, since the connection between ends of the plurality of spring wires of the elastic member and the first and second members of the slide device may be very simply and easily achieved by a simple structure, it may be possible to obtain a slide device that is further excellent in mass productivity and cost.

Furthermore, since a slide device capable of reliably and easily achieving the above-mentioned advantages is used in the embodiments of the invention, it may be possible to obtain a very practical electric device.

### BRIEF DESCRIPTION OF THE DRAWINGS

FIG. 1 is a perspective view of an elastic member of a slide device according to an embodiment;

FIG. 2 is an exploded perspective view of the slide device according to this embodiment;

FIG. 3 is a view illustrating the operation of the elastic member of the slide device according to this embodiment;

FIG. 4 is a view showing a usage state of an electric device using the slide device according to this embodiment;

FIG. 5 is a plan view showing another example of the elastic member of the slide device according to this embodiment;

FIG. 6 is a plan view showing another example of the elastic member of the slide device according to this embodiment;

FIG. 7 is a view showing another example of the elastic member of the slide device according to this embodiment;

FIG. 8 is a view showing another example of the elastic member of the slide device according to this embodiment;

FIG. 9 is a view showing another example of the elastic member of the slide device according to this embodiment; and

FIG. 10 is a view showing the prior art.

### DETAILED DESCRIPTION

A specific embodiment of the invention will be described below with reference to drawings.

An elastic member 4 of this embodiment is used between first and second members 1 and 2 of a slide device where the first and second members 1 and 2 are superposed and connected to each other so as to slide in a direction of a superposition surface.

The elastic member 4 includes a plurality of spring wires 4A that are elastically bent, and first and second connecting sections 5 and 6 that are locked to one ends and the other ends of the spring wires 4A, respectively.

Each of the spring wires 4A has the shape of a predetermined bent wire including an arcuately bent portion that maybe elastically bent in an arcuate shape, bent or curved locking ends 8 are formed at one ends and the other ends of the spring wires, and both ends of the spring wires 4A including the locking ends 8 are formed in a symmetrical shape.

The connecting sections 5 and 6 include retaining engagement portions 7 that make the ends of the plurality of spring wires 4A be engaged with the connecting sections 5 and 6 in a retaining state at predetermined intervals. The first and second connecting sections 5 and 6 are obtained by separately forming the same assembling members 5A and 6A and the same superposed members 5B and 6B, and fixing the assembling members 5A and 6A to the superposed members 5B and 6B while the superposed members are assembled to be superposed on the assembling members.

The superposition surfaces of one of the assembling members 5A and 6A and the superposed members 5B and 6B have a groove shape that substantially matches with the locking ends 8 of the spring wires 4A. A plurality of grooves 7a to which the locking ends 8 are fitted are formed on the superposition surfaces so that the plurality of grooves 7a are formed as the retaining engagement portions 7.

When the assembling members 5A and 6A are fixed to the superposed members 5B and 6B while the ends of the spring wires 4A are fitted to the grooves 7a of the retaining engagement portions 7 and the superposed members are assembled to be superposed on the assembling members as described above, the ends of the plurality of spring wires 4A are disposed at predetermined intervals and retained by the connecting sections 5 and 6.

In particular, unlike a conventional spring unit type device that requires a troublesome work for assembling an elastic member with a unit base while bending the compression-resistant springs, according to this embodiment of the invention, it may be possible to simply manufacture the elastic member 4 only by fixing each of the ends of the plurality of spring wires 4A, which correspond to a free-length state (free state), to the connecting sections 5 and 6. Accordingly, the elastic member is excellent in mass productivity and cost.

Various structures may be employed for the connecting sections 5 and 6. However, for example, like in the following embodiment, the ends of the plurality of spring wires 4A may be mounted to the connecting sections 5 and 6 in a retaining state at predetermined intervals.

That is, for example, when connecting sections 5 and 6 are structured to have retaining engagement portions 7 that make the ends of the spring wires 4A be engaged in a retaining state, and the ends of the spring wires 4A are formed in a flat shape and include bent or curved locking ends 8 that are formed by bending or curving the ends of the spring wires in a slide direction as a direction of a superposition surface between the first and second members 1 and 2 and are engaged with the retaining engagement portions 7 of the connecting sections 5 and 6, it may be possible to realize a retaining structure with a simple structure with the flat shape of the spring wires 4A (without increasing the thickness).

In particular, as will be described below, when the connecting sections 5 and 6 are formed by fixing the assembling members 5A and 6A to the superposed members 5B and 6B while the superposed members are assembled to be superposed on the assembling members, grooves 7a having a groove shape substantially matches with the locking ends 8 of the spring wires 4A are formed on the superposition surfaces of at least one of the assembling members 5A and 6A and the superposed members 5B and 6B so that the grooves 7a are formed as the retaining engagement portions 7, and the locking ends 8 of the spring wires 4A are retained to the connecting sections 5 and 6 by fixing the assembling members 5A and 6A to the superposed members 5B and 6B while the ends of the spring wires 4A are fitted to the grooves 7a of the retaining engagement portions 7 and the superposed members are assembled to be superposed on the assembling members, for example, when the grooves 7a are formed on the connecting sections 5 and 6 at predetermined intervals as shown in FIG. 2 and the locking end 8 of each of the spring wires 4A is fitted to each of the grooves 7a, it may be possible to simply assemble the plurality of spring wires 4A with the connecting sections 5 and 6 at desired intervals. Accordingly, when a mounting structure for mounting the plurality of spring wires 4A to the first member 1 or the second member 2 by the connecting sections 5 and 6 as described above is employed, it may be possible to very simply and reliably mount the plurality of spring wires 4A to the first member 1 and the second member 2 at desired intervals and to more easily manufacture the elastic member, so that the elastic member is excellent in mass productivity and cost.

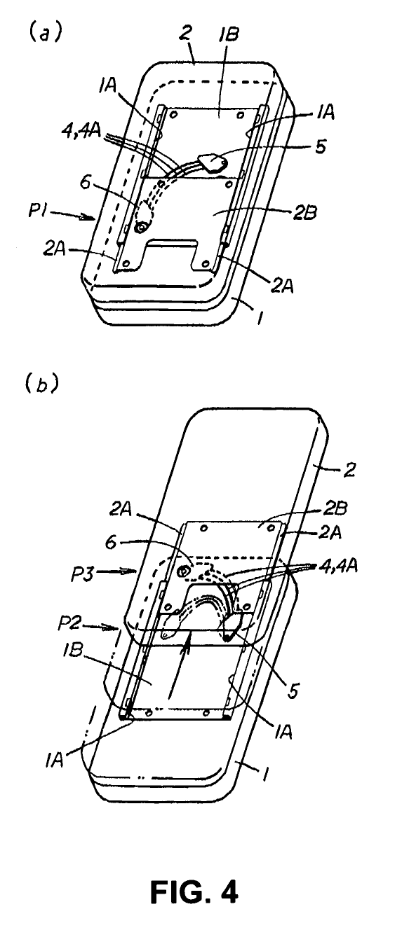

In FIG. 4, the invention is applied to an electric device where a superposed unit is superposed on a main body unit and the main body unit and the superposed unit are connected to each other by a slide device so that the superposed unit slides to relatively cross from the superposed state in a direction of a superposition surface and exposes a part of the superposition surface to the outside. Specifically, the invention is applied to a slide mobile phone; a main body unit, which includes an operating section including numerical keys and function keys on an upper surface of the main body unit, is used as the first member 1; a superposed unit, which is slidably superposed on the main body unit and is opened and closed to hide and expose the operating section, is used as the second member 2; a display section such as a liquid crystal panel for performing predetermined display is provided on the upper surface of the second member 2; and the first member 1 and the second member 2 are connected to each other by a slide device so as to slide relative to each other.

As shown in FIG. 4, slide guides 1A, which have the shape of a U-shaped guide rail, are provided on the left and right sides on the upper surface of the first member 1 so as to face each other. Specifically, the slide guides 1A are formed on the left and right sides by folding left and right edges of a slide guide forming plate 1B that is provided on the upper surface of the first member 1.

On the other hand, the second member 2 is provided with a slide portion 2A that is slidably engaged between the left and right slide guides 1A. Specifically, plate edges, which serve as slide portions 2A slidably engaged with the slide guides 1A, protrude from left and right edges of a slide portion forming plate 2B that is provided on the lower surface of the second member 2. The plate edges serving as the slide portions 2A are slidably engaged with the left and right slide guides 1A of the first member 1, so that the first member 1 and the second member 2 are connected to each other so as to slide relative to each other.

One end of the elastic member 4 is pivotally connected to a predetermined portion of the upper surface of the slide guide forming plate 2B of the first member 1 and the other end of the elastic member 4 is pivotally connected to a predetermined portion of the lower surface of the slide guide forming plate 2B of the second member 2 so that both ends of the elastic member 4 are connected to the first and second members 1 and 2, respectively.

Meanwhile, for example, the slide guide 1A itself may be structured as the first member 1, and one end of the elastic member 4 may be connected to the slide guide 1A provided as the first member 1. Further, for example, one end of the elastic member 4 maybe connected to the first member 1 through the slide guide 1A by connecting one end of the elastic member 4 to the slide guide 1A that is provided at the first member 1. Likewise, for example, the slide portion 2A itself may be structured as the second member 2, and the other end of the elastic member 4 may be connected to the slide portion 2A provided as the second member 2. Further, for example, the other end of the elastic member 4 may be connected to the second member 2 through the slide portion 2A by connecting the other end of the elastic member 4 to the slide portion 2A that is provided at the slide portion 2A.

In this embodiment, the ends of the plurality of spring wires 4A are locked or fixed to the connecting sections 5 and 6, which connect the ends of the plurality of spring wires 4A forming the elastic member 4 to the first member 1 or the second member 2, in a retaining state at predetermined intervals.

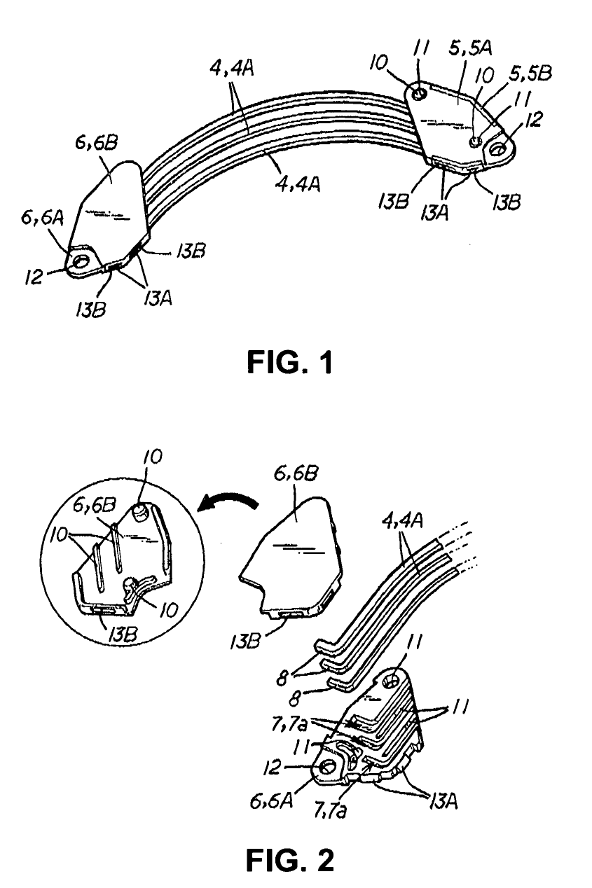

As shown in FIGS. 1 and 2, each of the spring wires 4A is formed in an arcuate shape as a whole, the left and right ends of each spring wire are bent in an L shape, and L-shaped locking ends 8 to be described below are provided at the left and right ends of the middle arcuately bent portion that may be elastically bent in an arcuate shape. Further, in this embodiment, three spring wires 4A are used as the elastic member 4, and the spring wires 4A have different widths.

Meanwhile, in this embodiment, each spring wire 4A has been formed by bending a metal wire in the above-mentioned shape. However, for example, the spring wire may be formed by pressing or frame molding in the shape of a predetermined bent wire.

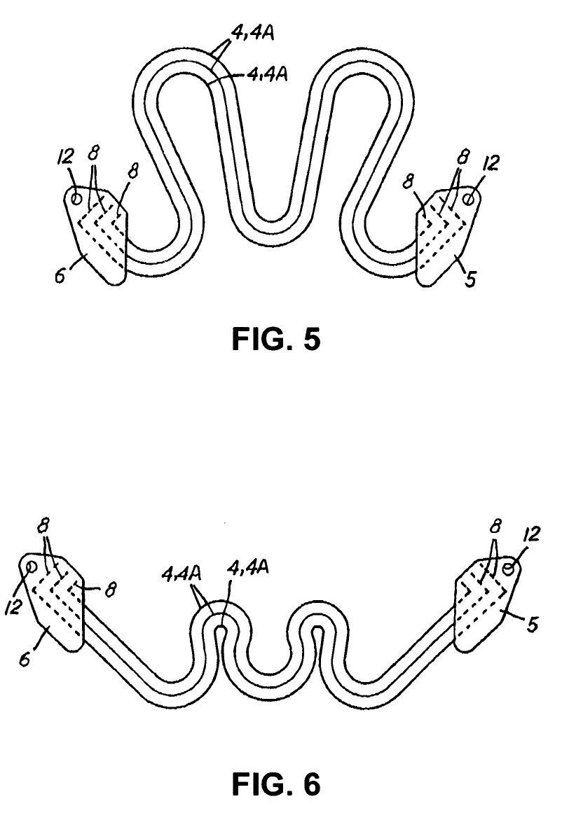

Further, the shape of the spring wire 4A is not limited to the arcuate shape as a whole in this embodiment. For example, as shown in FIGS. 5 and 6, the spring wire may be formed in a meandering shape to include a plurality of folded portions between left and right ends thereof. If the spring wire is formed in the meandering shape as described above, a distance between the left and right ends of the spring wire 4A may be set to be short, which is optimum for setting a short sliding distance.

In addition, it may be possible to simply and variously adjust the strength of an elastic force of the elastic member 4 by appropriately setting the length, shape, or the number of the spring wires 4A in consideration of required operability or a sliding distance.

For example, these spring wires 4A may be fixed by fixing the ends of the spring wires 4A to the connecting sections 5 and 6 by screws or fixing the ends of the spring wires to the connecting sections by an adhesive. However, in this embodiment, the retaining engagement portions 7 that make the ends of the spring wires 4A be engaged with the connecting sections 5 and 6 in a retaining state are formed as shown in FIG. 2, and the spring wires 4A include the bent or curved locking ends 8 that are formed by bending or curving the ends of the spring wires in a slide direction as a direction of a superposition surface between the first and second members 1 and 2 and are engaged with the retaining engagement portions 7 of the connecting sections 5 and 6 as shown in FIG. 2. Accordingly, the locking ends 8 of the spring wires 4A are engaged with the retaining engagement portions 7 of the connecting sections 5 and 6, respectively, so that the ends of the spring wires 4A are locked to the connecting sections 5 and 6 in a retaining state.

In this embodiment, the locking ends 8 are formed by bending the left and right ends of the spring wires 4A, which are formed in an arcuate as a whole, in an L shape as described above, the locking ends 8 may be simply formed at both ends of the spring wires only by bending or curving both ends of the spring wires 4A, and the ends of the spring wires are bent or curved in a slide direction as a direction of a superposition surface between the first and second members 1 and 2. Accordingly, the flat shape is maintained and the thickness of the spring wires 4A is not increased by the locking ends 8.

Further, as shown in FIG. 2, the connecting sections 5 and 6 are formed by fixing the assembling members 5A and 6A to the superposed members 5B and 6B while the superposed members are assembled to be superposed on the assembling members. Furthermore, the grooves 7a having a groove shape substantially matches with the locking ends 8 of the spring wires 4A are formed on the superposition surfaces of at least one of the assembling members 5A and 6A and the superposed members 5B and 6B (the superposition surfaces of the assembling members 5A and 6A in this embodiment) so that the grooves 7a are formed as the retaining engagement portions 7. Meanwhile, each of the assembling members 5A and 6A and the superposed members 5B and 6B of the connecting sections 5 and 6 is formed of a molded product.

As shown in FIG. 2, the grooves 7a are formed to have a groove shape that substantially matches with the ends of the spring wires 4A including the locking ends 8. The locking ends 8 are formed in an L shape in this embodiment, so that each of the grooves 7a formed as the retaining engagement portions 7 is also formed of an L-shaped groove.

Further, grooves 7a are formed at three positions on the superposition surface of each of the assembling members 5A and 6A of the connecting sections 5 and 6 at predetermined intervals, that is, so as to correspond to the number of the spring wires 4A.

Accordingly, it may be possible to position the ends of the plurality of spring wires 4A in the grooves 7a at desired intervals by fitting the locking ends 8 of the spring wires 4A into the grooves 7a of the assembling members 5A and 6A, respectively.

Further, in this embodiment, convex portions 10 for superposition positioning are formed at one members of the assembling members 5A and 6A and the superposed members 5B and 6B that form the connecting sections 5and 6, and concave portions 11 to which the convex portion 10 are fitted are formed at the other members. The convex portions 10 are fitted to the concave portions 11, so that the superposed members 5B and 6B are superposed on the assembling members 5A and 6A while the superposed members and the assembling members are positioned.

Furthermore, lock convex portions 13A are formed at the rising outer edges of one members of the assembling members 5A and 6A and the superposed members 5B and 6B so as to protrude outward, and engagement portions 13B engaged with the lock convex portions 13A are formed at the rising edges of the other members. The superposed members 5B and 6B are disposed to be superposed on the assembling members 5A and 6A, so that the lock convex portions 13A are engaged with the engagement portions 13B and the superposed state is maintained.

Accordingly, a troublesome work does not need to be performed in this embodiment. When only a simple work for superposing the superposed members 5B and 6B is performed after the locking ends 8 of the spring wires 4A are fitted to the grooves 7a of the assembling members 5A and 6A, it may be possible to maintain the engagement between the superposed members 5B and 6B and the assembling members 5A and 6A in a superposed state and to lock the locking ends 8 of the spring wires 4A to the grooves 7a in a retaining state, respectively. Therefore, it may be possible to simply assemble and manufacture the elastic member 4 with high workability.

Further, in this embodiment, both ends of each of the spring wires 4A, which include the locking ends 8, are formed in a symmetrical shape. Accordingly, the assembling members 5A and 6A of the first and second connecting sections 5 and 6 have the same shape, the superposed members 5B and 6B of the first and second connecting sections 5 and 6 also have the same shape, and the assembling members 5A and 6A and the superposed members 5B and 6B are mounted to the left and right ends of the spring wires 4A so that the positions of the assembling members and the superposed members are reversed in a vertical direction.

As described above, the elastic member 4 according to this embodiment does not require expensive components, and is merely formed by the combination of several spring wires 4A that are formed by bending wires and connecting sections 5 and 6 that are formed of molded members (assembling members 5A and 6A and superposed members 5B and 6B). Accordingly, it may be possible to reduce component cost. Further, since the assembly of the elastic member 4 may also be simply performed with high workability, the elastic member 4 is also excellent in mass productivity. In general, it is difficult to directly connect the plurality of spring wires 4A to the first member 1 or the second member 2 at desired intervals. However, in this embodiment, it may be possible to reliably and easily connect each of the spring wires 4A to the first member or the second member at desired intervals and to very simply connect the plurality of spring wires 4A to the first member 1 or the second member 2 by employing the above-mentioned connecting structure that uses the connecting sections 5 and 6. Accordingly, it may be possible to obtain a structure that is excellent in mass productivity and cost.

Meanwhile, pivot holes 12 are formed at predetermined portions of the assembling members 5A and 6A of the connecting sections 5 and 6, respectively. Specifically, as shown in FIGS. 1 and 2, the pivot holes 12 are formed at the other portions opposite to one portions of the connecting sections 5 and 6 where each of the spring wires 4A protrudes toward the side, respectively. The ends of the spring wires 4A are pivotally and rotatably connected to the first member 1 or the second member 2 by the connecting sections 5 and 6 by pivotally connecting the connecting sections 5 and 6 to the first member 1 or the second member 2 through the pivot holes 12.

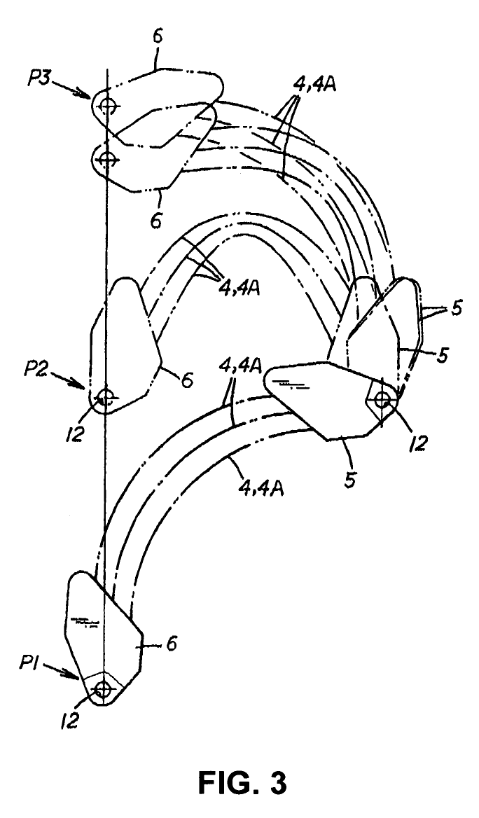

FIG. 3 is a view illustrating the operation of the elastic member 4 when the second member 2 slides with respect to the first member 1 of this embodiment having the above-mentioned structure. A member, which is provided at the right end in FIG. 3, of the connecting sections 5 and 6, which are provided at the left and right ends of the elastic member 4, is the first connecting section 5 that is pivotally connected to the first member 1. A member, which is provided at the left end in FIG. 3, is the second connecting section 6 that is pivotally connected to the second member 2.

In FIG. 3, reference numeral P1 denotes the position of the second connecting section 6 relative to the first connecting section 5 when the second member 2 (superposed unit) is positioned at a superposed closed position with respect to the first member 1 (main body unit) as shown in FIG. 4(a). Reference numeral P2 denotes the position of the second connecting section 6 when the second member 2 slides relative to the first member 1 and the positions of the first and second connecting sections 5 and 6 are lined up in a horizontal direction orthogonal to the slide direction. Reference numeral P3 denotes the position of the second connecting section 6 relative to the first connecting section 5 when the second member 2 is positioned at a slide open position with respect to the first member 1 as shown in FIG. 4(b).

In this embodiment, the elastic member 4 is set so that each of the spring wires 4A is not in a free-length state (free state) and a force in a slide direction is generated where the connecting sections 5 and 6 are still separated from each other by the elasticity of each of the spring wires 4A while the second connecting section 6 is positioned at the position P1 or the position P3 with respect to the first connecting section 5 as shown in FIG. 3.

Accordingly, when the second member 2 is positioned at the superposed closed position with respect to the first member 1 as shown in FIG. 4 (a), the second member 2 is positioned and maintained at the superposed closed position by the elastic member 4. Further, when the second member 2 is positioned at the slide open position with respect to the first member 1 as shown in FIG. 4(b), the second member 2 is positioned and maintained at the slide open position by the elastic member 4.

Furthermore, when the second member 2 slides relative to the first member 1, a returning force for returning the second member 2 in the slide direction is generated until the second member 2 slides relative to the first member 1 by a predetermined distance (specifically, until the second connecting section 6 reaches the position P2 with respect to the first connecting section 5 as shown in FIG. 3). However, if the second member 2 is moved by a predetermined distance, an advancing force for advancing the second member 2 in the slide direction is generated in contrast. That is, for example, when the second member 2 slides relative to the first member 1 from the superposed closed position to the slide open position, a returning force is generated in a slide range where the second connecting section 6 reaches the position P2 from the position P1 with respect to the first connecting section 5 as shown in FIG. 3. In contrast, an advancing force is generated in a slide range where the second connecting section 6 reaches the position P3 from the position P2.

Further, in this embodiment, the connecting sections 5 and 6 include two components (assembling members 5A and 6A and the superposed members 5B and 6B), respectively, and the ends of each of the spring wires 4A are locked to the connecting sections 5 and 6 in a retaining state so that the spring wires are provided between the two components.

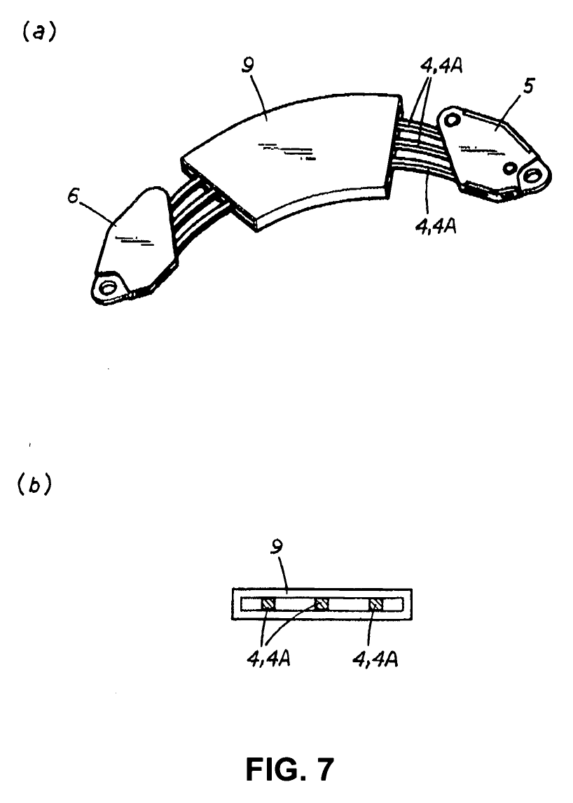

Meanwhile, for example, like modifications of this embodiment shown in FIGS. 7, 8, and 9, a protective member 9 covering the middle portions of the spring wires 4A between the connecting sections 5 and 6of the elastic member 4 may be provided if necessary.

In detail, for example, FIG. 7 shows a structure where the spring wires 4A pass through a box-shaped (cylindrical) molded product that serves as the protective member 9 and upper and lower sides of the middle portions of the spring wires 4A of the elastic member 4 are protected by the protective member 9. The protective member 9 is formed of in the shape of a box (cylinder) having clearance enough to allow the spring wires 4A to be elastically deformed so that the box-shaped protective member 9 does not obstruct the elastic deformation of the spring wires 4.

There is a concern in that the metal spring wires 4A are in contact with and slide on other components as described above, so that other components are scratched or a surface layer is peeled. However, in this embodiment, the protective member 9 may reliably suppress the contact between the spring wire 4A and other components that are disposed above and below the spring wires 4A (the protective member 9 is in contact with other components). Accordingly, it may be possible to suppress a trouble that deteriorates slide operability or causes operation failure, such as surface-treated layers (coating and the like) of other components are peeled or other components are scratched by the spring wires 4A, and the peeled layers (wastes) enter or remain in specific portions, thereby causing the trouble.

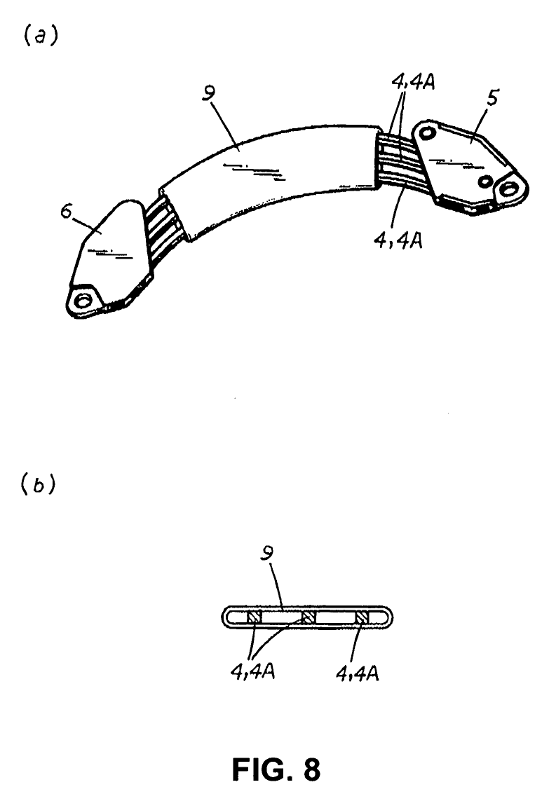

Further, for example, FIG. 8 shows a structure where the middle portions of the spring wires 4A of the elastic member 4 are surrounded by a rubber tube serving as the protective member 9. Since the rubber tube suppresses the contact between the spring wires 4A and other components like the protective member 9 shown in FIG. 7, a good protective effect is obtained. Furthermore, in particular, since the protective member 9 is formed of a rubber tube, noise caused by the slide is further hardly generated even though the protective member 9 slides on other components.

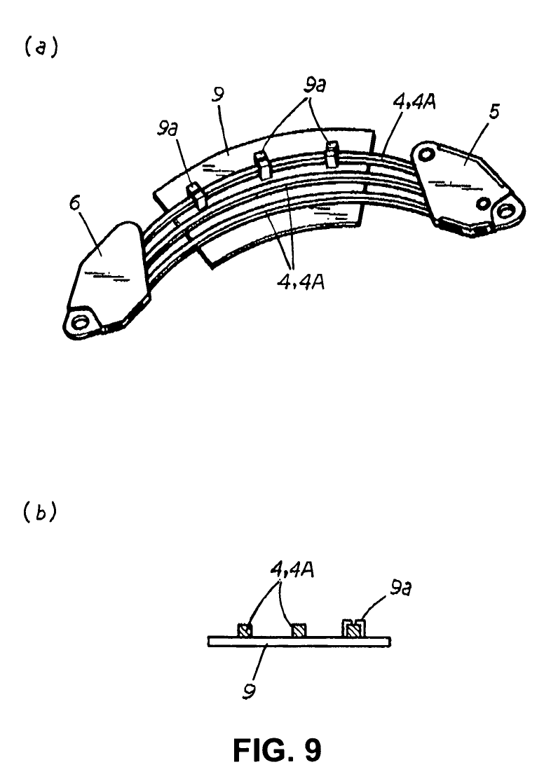

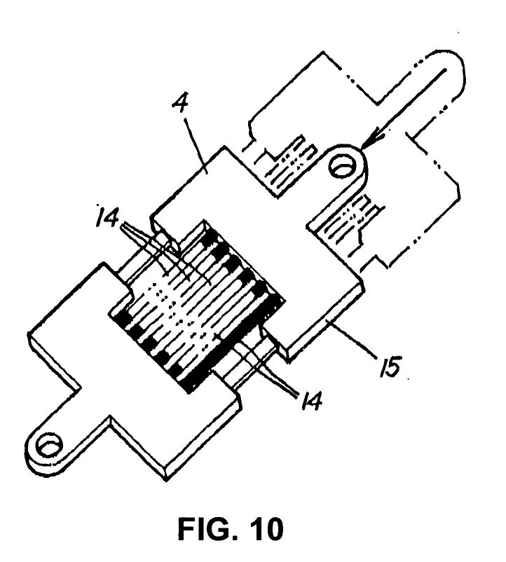

For example, FIG. 9 shows a structure where only one side of the elastic member 4, that is, one side of the middle portion of each of the spring wires 4 is covered with and protected by a plate-like protective member 9. Specifically, a plurality of hook-shaped or claw-shaped locking portions 9a, which are locked to the peripheries of the spring wires 4A of the elastic member 4, are formed at predetermined portions of a flat plate. In the embodiment shown in FIG. 9, three locking portions 9a, which lock a predetermined spring wire 4A of the plurality of spring wires 4A of the elastic member 4, are provided at three positions at predetermined intervals in the longitudinal direction. Accordingly, it may be possible to reliably mount the protective member 9 to the elastic member 4, and there is no concern that the protective member 9 has harmful effects on the elastic deformation of the spring wires 4A. In general, one sides of the spring wires 4 are exposed to the outside and are in contact with other components due to the structure of the slide device. Accordingly, when only one sides of the spring wires, which are in contact with other components, are protected by the protective member 9, the same good protective effect as the protective members 9 shown in FIGS. 7 and 8 is obtained.

The elastic member according to the embodiment of the invention may be generally applied to a slide device where first and second members are superposed and connected to each other so as to slide in a direction of a super position surface. Further, the slide device has been used for a mobile phone in the embodiment. However, the slide device may be generally used for a device that is opened/closed or rotated in addition to the mobile phone, and may be applied to another electric device regardless of whether it is a mobile phone or not.

It should be understood by those skilled in the art that various modifications, combinations, sub-combinations and alterations may occur depending on design requirements and other factors insofar as they are within the scope of the appended claims or the equivalents thereof.

What is claimed is:

1. An elastic member used between first and second members of a slide device where the first and second members are superposed and connected to each other so as to slide in a direction of a superposition surface, the elastic member comprising:
a plurality of spring wires that are elastically bent; and
first and second connecting sections that are locked to one ends and the other ends of the spring wires, respectively,
wherein each of the spring wires includes an arcuately bent portion,
bent or curved locking ends are formed at one ends and the other ends of the spring wires,
both ends of each of the spring wires including the locking ends are formed in a symmetrical shape,
the connecting sections include retaining engagement portions that make the ends of the plurality of spring wires be engaged with the connecting sections in a retaining state at predetermined intervals,
the first and second connecting sections are obtained by separately forming the same assembling members and the same superposed members, and fixing the assembling members to the superposed members while the superposed members are assembled to be superposed on the assembling members,
the superposition surfaces of one of the assembling members and the superposed members have a groove shape that substantially matches with to the locking ends of the spring wires,
a plurality of grooves to which the locking ends are fitted are formed on the superposition surfaces so that the plurality of grooves are formed as the retaining engagement portions, and
when the assembling members are fixed to the superposed members while the ends of the spring wires are fitted to the grooves of the retaining engagement portions and the superposed members are assembled to be superposed on the assembling members, the ends of the plurality of spring wires are disposed at predetermined intervals and retained by the connecting sections.

2. A slide device where pivot holes, which are used to connect first and second connecting sections to first and second members of the slide device, respectively, are formed at portion of the first and second connecting sections of the elastic member according to claim 1, which are fixed while being superposed, opposite to spring wires,
wherein the pivot hole of the first connecting section is connected to the first member of the slide device and the pivot hole of the second connecting section is connected to the second member so that an elastic force in a slide direction is generated between the first and second members.

3. An electric device where a main body unit and a superposed unit of an electric device are superposed and the main body unit and the superposed unit are connected to each other by the slide device according to claim 2 so that the superposed unit slides to relatively cross from the superposed state in a direction of a superposition surface and exposes a part of the superposition surface to the outside.
